(19) United States
(12) Patent Application Publication
(10) Pub. No.: US 2012/0058684 A1
(43) Pub. Date: Mar. 8, 2012

(54) LOW-CROSS-TALK ELECTRICAL CONNECTOR

(76) Inventors: Jan De Geest, Wetteren (BE); Stefaan Hendrik Jozef Sercu, Wuustwezel (BE); Jonathan E. Buck, Hershey, PA (US); Douglas M. Johnescu, York, PA (US); Stuart C. Stoner, Lewisberry, PA (US); Stephen B. Smith, Mechanicsburg, PA (US)

(21) Appl. No.: 13/220,802

(22) Filed: Aug. 30, 2011

Related U.S. Application Data
(63) Continuation-in-part of application No. 13/081,323, filed on Apr. 6, 2011.
(60) Provisional application No. 61/379,912, filed on Sep. 3, 2010.

(51) Int. Cl. H01R 24/00; G09B 23/18

(52) U.S. Cl. 439/660; 434/301

(57) ABSTRACT

An electrical connector includes a plurality of leadframe assembly, each having a leadframe housing and a plurality of contacts carried by the leadframe housing. At least a pair of adjacent leadframe assemblies includes respective first and second conductive member portions that are seated in the leadframe housing at a desired location with respect to the corresponding electrical contacts.

### CROSS-REFERENCE TO RELATED APPLICATIONS

This is a continuation-in-part of U.S. patent application Ser. No. 13/081,323 filed Apr. 6, 2011, the disclosure of which is hereby incorporated by reference as if set forth in its entirety herein. This also claims the benefit of U.S. patent application Ser. No. 61/379,912 filed Sep. 3, 2010, the disclosure of which is hereby incorporated by reference as if set forth in its entirety herein.

### TECHNICAL FIELD

The present disclosure relates generally to the field of electrical connectors, and in particular relates to an electrical connector that is configured to reduce cross-talk between adjacent signal contacts.

### BACKGROUND

Electrical connectors provide signal connections between electronic devices using electrically-conductive contacts, or electrical contacts. In some applications, an electrical connector provides a connectable interface between one or more substrates, e.g., printed circuit boards. Such an electrical connector may include a receptacle connector mounted to a first substrate and a complementary header connector mounted to a second substrate. Typically, a first plurality of electrical receptacle contacts in the receptacle connector is adapted to mate with a corresponding plurality of electrical header contacts in the header connector. For instance, the electrical receptacle contacts can receive the electrical header contacts so as to establish an electrical connection between the electrical receptacle contacts and the electrical header contacts.

The electrical contacts typically include a plurality of signal contacts and ground contacts. Often, the signal contacts are so closely spaced that undesirable interference, or “cross talk,” occurs between adjacent signal contacts. As used herein, the term “adjacent” refers to contacts (or rows or columns) that are next to one another. Cross talk occurs when one signal contact induces electrical interference in an adjacent signal contact due to intermingling electrical fields, thereby compromising signal integrity. With electronic device miniaturization and high speed, high signal integrity electronic communications becoming more prevalent, the reduction of cross talk becomes a significant factor in connector design.

### SUMMARY

In accordance with one embodiment, an electrical connector includes a connector housing, a first leadframe assembly supported by the connector housing, and a second leadframe supported by the connector housing. The first leadframe assembly includes a first leadframe housing and a corresponding plurality of electrical contacts carried by the first leadframe housing. The second leadframe assembly that is adjacent to the first leadframe assembly and includes a second leadframe housing and a corresponding plurality of electrical contacts carried by the second leadframe housing. The electrical connector further includes an electrically conductive member including a first portion and a second portion configured to engage the first portion. The first portion is supported by the first leadframe housing so as to define a gap with respect to the plurality of electrical contacts corresponding to the first leadframe assembly, and the second portion carried by the second leadframe housing so as to define a gap with respect to the plurality of electrical contacts corresponding to the second leadframe assembly. The first and second portions face each other when the first and second leadframe assemblies are supported by the connector housing.

### BRIEF DESCRIPTION OF THE DRAWINGS

FIG. 1A is a perspective view of an electrical connector assembly including a first electrical connector and a second electrical connector that can each be mounted to respective printed circuit boards and mated so as to place the printed circuit boards in electrical communication;

FIG. 1B is a perspective view of the electrical connector assembly illustrated in FIG. 1A, showing the first and second electrical connectors aligned to be mated with each other;

FIG. 2A is a perspective view of a first leadframe assembly including a first portion of an electrically conductive bar;

FIG. 2B is a perspective view of a second leadframe assembly including a second portion of the electrically conductive bar illustrated in FIG. 2A;

FIG. 3 is a perspective view of the first and second portions of the electrically conductive bar illustrated in FIG. 2;

FIG. 4 is an enlarged perspective view of a select region of the first and second portions of the electrically conductive bar illustrated in FIG. 3 so as to illustrate a bias assembly.

FIG. 5A is a perspective view of the first and second portions of the electrically conductive bar illustrated in FIG. 3, shown in an engaged configuration;

FIG. 5B is a side elevation view of the electrically conductive bar illustrated in FIG. 5A; and

FIG. 5C is a sectional side elevation view of the electrically conductive bar illustrated in FIG. 5B, taken along line 5C-5C.

### DETAILED DESCRIPTION

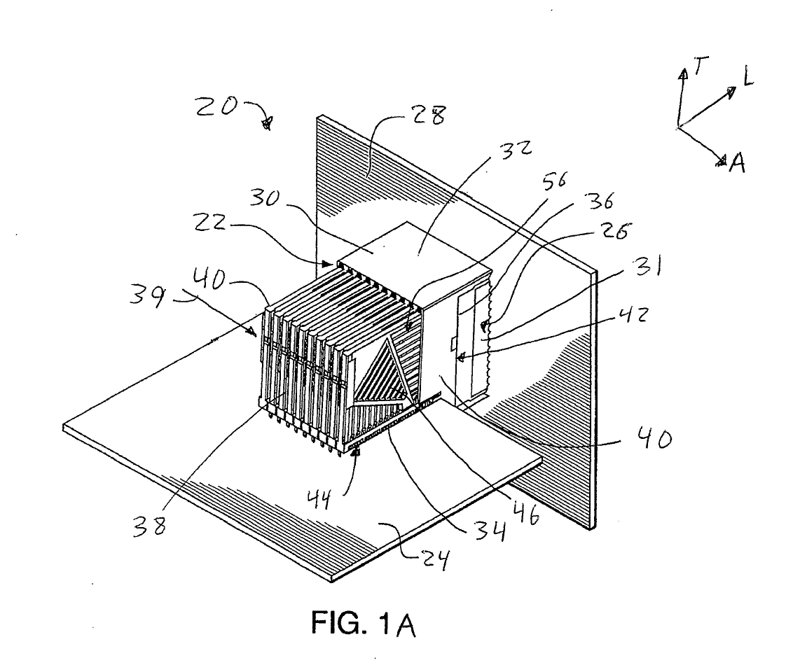

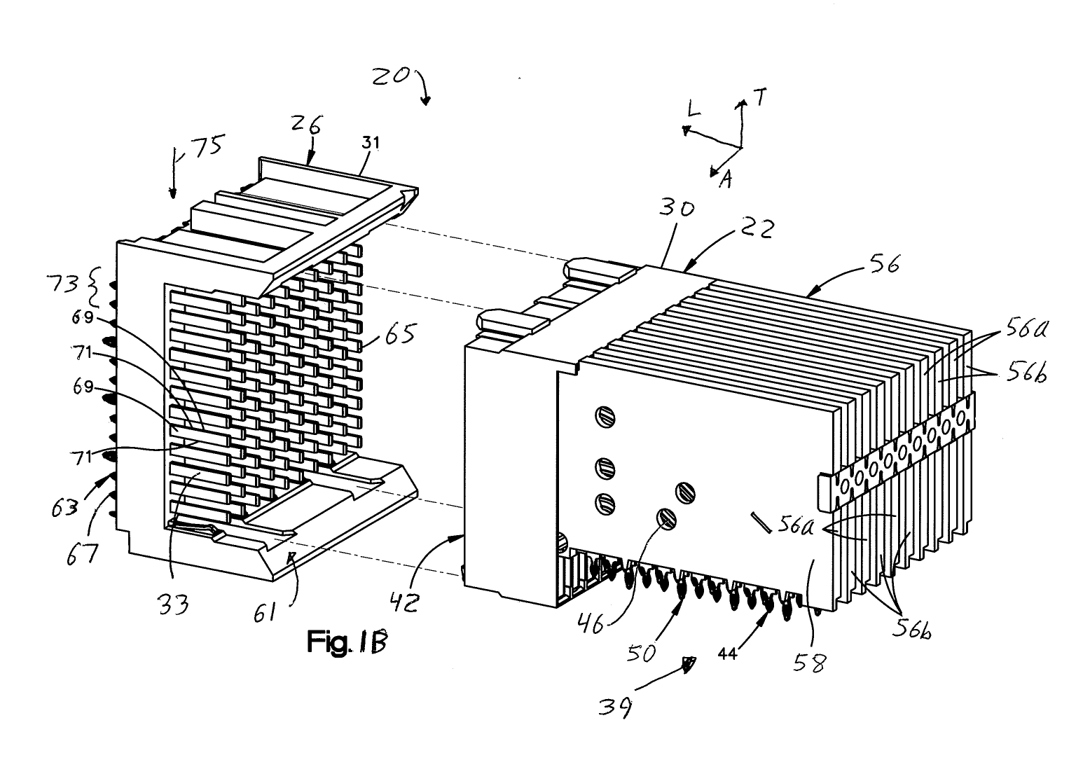

Referring to FIGS. 1A-B, an electrical connector system 20 includes a first electrical connector 22 configured to be electrically connected to a first substrate 24 which can be provided as a printed circuit board (PCB), and a second electrical connector 26 configured to be electrically connected to a second substrate 28 such as a PCB. The first and second electrical connectors 22 and 26 are configured to mate with each other so as to place the first and second substrates 24 and 28 in electrical communication with each other. The electrical connector system 20 can be constructed generally as described in U.S. Pat. No. 7,331,800, the disclosure of which is hereby incorporated by reference as if set forth in its entirety herein.

The first electrical connector 22 includes a connector housing 30 that is dielectric or electrically insulative. Housing 30 may also be made from a frequency absorber, such as an electrically conductive or electrically insulative lossy material. The housing may have vertical ribs that separate leadframe assemblies 56, or may be devoid of the ribs. The first electrical connector 22 defines a top end 32 and an opposed bottom end 34, a front end 36 and an opposed rear end 38, and opposed sides 40. The opposed front and rear ends 36 and 38 are spaced apart along a longitudinal direction L, the opposed sides 40 are spaced apart along a lateral direction A that is substantially perpendicular with respect to the longitudinal direction L, and the top and bottom ends 32 and 34 are spaced apart along a transverse direction T that is substantially perpendicular with respect to the lateral direction A and the longitudinal direction L. In accordance with the illustrated embodiment, the transverse direction T is oriented vertically, and the longitudinal and lateral directions L and A are oriented horizontally, though it should be appreciated that the orientation of the first electrical connector 22 may vary during use. In accordance with the illustrated embodiment, the first and second electrical connectors 26 are configured to be mated with each other along a mating direction M, which can extend along the longitudinal direction L.

The first electrical connector 22 defines a mating interface 42 disposed proximate to the front end 36 and a mounting interface 44 disposed proximate to the bottom end 34. The mounting interface 44 is configured to operatively engage the first substrate 24, while the mating interface 42 is configured to operatively engage the second electrical connector 26. As shown, the first electrical connector 22 can be a right-angle electrical connector, whereby the mating interface 42 and the mounting interface 44 are oriented substantially perpendicular to each other, though it should be appreciated that the first electrical connector can alternatively be a vertical connector whereby the mating interface 42 and the mounting interface 44 are oriented substantially parallel to each other.

The first electrical connector 22 includes a plurality of electrical contacts 46 that are electrically conductive and supported by the connector housing 30. In accordance with the illustrated embodiment, the first electrical connector 22 includes a plurality of leadframe assemblies 56 that are arranged along a laterally extending row direction 39. The plurality of leadframe assemblies 56 can include a plurality of first leadframe assemblies 56a and a plurality of second leadframe assemblies 56b that are alternatingly arranged along the row direction 39. Thus, each of the first leadframe assemblies 56a can be disposed between a pair of second leadframe assemblies 56b or adjacent a second leadframe assembly 56b. Likewise, each of the second leadframe assemblies 56b can be disposed between a pair of first leadframe assemblies 56a or adjacent a first leadframe assembly 56a. Each of the plurality of first leadframe assemblies 56a can have a first electrical contact arrangement, and each of the plurality of second leadframe assemblies 56b can have a second electrical contact arrangement that differs from the first contact arrangement of each of the plurality of first leadframe assemblies 56a. Alternatively, the first and second leadframe assemblies 56a and 56b can define the same arrangement of electrical contacts.

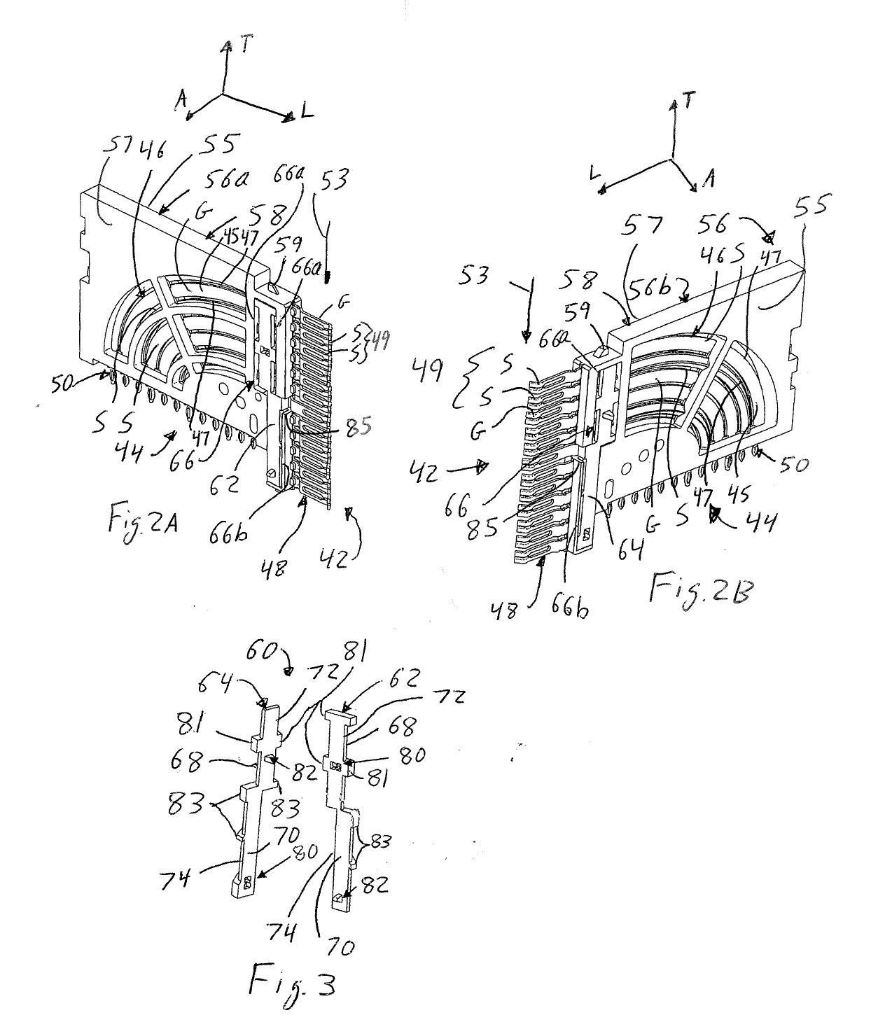

Referring also to FIGS. 2A-B, each leadframe assembly 56 can include a leadframe housing 58 that can be a dielectric or electrically insulative material. Each leadframe housing 58 can support a respective plurality of the electrical contacts 46 arranged along corresponding common transverse columns LC. The leadframe housing 58 of each leadframe assembly 56 defines laterally opposed first and second outer surfaces 55 and 57 that are spaced apart along the row direction 39, such that the first outer surface 55 of a first one of the leadframe housings 58 of a first select one of the leadframe assemblies 56 faces the second outer surface 57 of a second select one of the leadframe housings 58 of a second one of the leadframe assemblies 56 that is adjacent the first select one of the leadframe assemblies 56. The first select one of the leadframe assemblies 56 can be a first leadframe assembly 56a or a second leadframe assembly 56b, and the second select one of the leadframe assemblies 56 can be the other of the first leadframe assembly 56a and the second leadframe assembly 56b.

In accordance with one embodiment, the leadframe assemblies 56 can be insert molded leadframe assemblies (IMLAs) whereby the respective electrical contacts 46 are overmolded by the corresponding leadframe housing 58. Alternatively, the electrical contacts 46 can be stitched or otherwise fixed in the respective leadframe housing 58. The leadframe housings 58 include engagement members illustrated as tabs 59 that are configured to engage respective engagement members of the connector housing 30 so as to secure the position of the respective leadframe housings 58 in the connector housing 30.

The electrical contacts 46 can include a plurality of signal contacts S that are configured to carry and transmit data signals to the complementary second electrical connector 26, and a plurality of ground contacts G. Any suitable dielectric material, such as air or plastic, may be used to isolate the electrical signal contacts 46 of one leadframe assembly 56 from an adjacent leadframe assembly 56. The electrical contacts 46 each define respective mating ends 48 that extend along the mating interface 42, and extend laterally forward from the leadframe housing 58 and are configured to mate with complementary mating ends of the electrical contacts of the second electrical connector 26. The electrical contacts 46 further define opposed mounting ends 50 that extend along the mounting interface 44. The mounting ends 50 may be press-fit tails, surface mount tails, or fusible elements such as solder balls, which are configured to electrically connect to a complementary electrical component such as the first substrate 24, which can be configured as a backplane, midplane, daughtercard, or the like. The electrical contacts 46 can be right-angle electrical contacts, whereby the mounting ends 50 extend in a direction substantially perpendicular to the mating ends 48. Alternatively, the electrical contacts 46 can be vertical electrical contacts, whereby the mounting ends 50 extend in a direction substantially parallel to the mating ends 48.

Each of the electrical contacts 46 can define respective first and second opposed broadsides 45 and first and second edges 47 connected between the broadsides. The edges 47 define a length less than that of the broadsides 45, such that the electrical contacts 46 define a rectangular cross section. Because the mating ends 48 of the electrical contacts 46 are configured as receptacles that receive mating ends of electrical contacts of the complementary second electrical connector 24, the first electrical connector 22 can be referred to as a receptacle connector, though it should be appreciated that the first electrical connector 22 can alternatively be configured as a plug or header connector whereby the mating ends 48 are configured as plugs that are receive by the electrical contacts of the complementary second electrical connector 24.

At least one or more pairs of adjacent electrical contacts 46 can be configured as differential signal pairs 49. In accordance with one embodiment, the differential signal pairs 49 are edge coupled, that is the edges 47 of each electrical contact 46 of a given differential pair 49 face each other along a transverse common column 53 that is substantially perpendicular to the row direction 39. Thus, the leadframe assemblies 56 can be spaced along a longitudinal row direction 39, and the electrical contacts 46 of each leadframe assembly 56 are spaced along the respective column 53, such that the electrical contacts 46 of adjacent leadframe assemblies 56 are arranged in spaced substantially parallel columns 53. Thus, the first electrical connector 22 can include a plurality of differential signal pairs 49 arranged along a given column 53. The first electrical connector 22 can include any number of differential signal pairs 49 positioned edge-to-edge along the respective columns 53, though the first electrical connector 22 can include any number of differential signal pairs along a given column as desired, such as two, three, four, five, six, or more differential signal pairs.

As described above, the electrical contacts 46 can include a plurality of signal contacts S and a plurality of ground contacts G. Further, as described above, the leadframe assemblies 56 can include two different types of leadframe assemblies that are alternately arranged along the row direction 39. Each of the plurality of first leadframe assemblies 56a can include an arrangement of the electrical contacts 46 in a repeating G-S-S pattern along a direction from the top of the respective leadframe housing 58 toward the bottom of the respective leadframe housing 58 at the mating interface 42. Each of the plurality of second leadframe assemblies 56b can include an arrangement of the electrical contacts 46 in a repeating S-S-G pattern along a direction from the top of the respective leadframe housing 58 toward the bottom of the respective leadframe housing 58 at the mating interface 42. Thus, the first and second leadframe assemblies 56a-b can define different patterns of signal and ground contacts. Alternatively, the first and second leadframe assemblies 56a-b can define the same pattern of signal contacts S and ground contacts G. Adjacent pairs of signal contacts S of each leadframe assembly 56 can define differential signal pairs 49, or the signal contacts S can alternatively be single ended. It should be further appreciated that the mating interface 42 can define an open pin field, such that the ground contacts G can alternatively be provided as signal contacts that can have a data transfer speed that is different (for instance less) than that of the signal contacts S. Thus, reference herein to contacts G is made for illustrative purposes only, it being appreciated that the contacts G can be ground contacts as described above, or can alternatively provide signal contacts during operation.

With continuing reference to FIGS. 1A-B, the second electrical connector 26 includes a dielectric connector housing 31 that supports a plurality of electrical contacts 33, which can include signal contacts and ground contacts. The second electrical connector 26 defines a mating interface 61 configured to mate with the mating interface 42 of the first electrical connector 22 when the first and second electrical connectors 22 and 26 are mated. The second electrical connector further defines a mounting interface 63 that is configured to operatively engage the second substrate 28. As shown, the second electrical connector 26 can be a vertical electrical connector, whereby the mating interface 61 and the mounting interface 63 are oriented substantially parallel to each other, though it should be appreciated that the second electrical connector 26 can alternatively be a right-angle connector whereby the mating interface 61 and the mounting interface 63 are oriented substantially perpendicular to each other.

The electrical contacts 33 may be insert molded prior to attachment to the connector housing 31, stitched into the connector housing 31, or otherwise supported by the connector housing 31. The electrical contacts 33 define respective mating ends 65 that extend along the mating interface 61, and mounting ends 67 that extend along the mounting interface 63. Each of the electrical contacts 33 can define respective first and second opposed broadsides 69 and first and second edges 71 connected between the broadsides 69. The edges 71 define a length less than that of the broadsides 69, such that the electrical contacts 33 define a rectangular cross section. The mounting ends 67 may be press-fit tails, surface mount tails, or fusible elements such as solder balls, which are configured to electrically connect to a complementary electrical component such as the second substrate 28, which can be configured as a backplane, midplane, daughtercard, or the like.

At least one or more pairs of adjacent electrical contacts 33 can be configured as differential signal pairs 73. In accordance with one embodiment, the differential signal pairs 73 are edge coupled, that is the edges 71 of each electrical contact 33 of a given differential signal pair 73 face each other along a common column 75 that extends in the transverse direction T. Thus, the second electrical connector 26 can include a plurality of differential signal pairs 73 arranged along respective column 75. The second electrical connector 26 can include any number of differential signal pairs 73 as desired that can be positioned edge-to-edge along the respective common column 75.

Because the mating ends 65 of the electrical contacts 33 are configured as plugs that are configured to be received by the mating ends 48 of the electrical contacts of the complementary first electrical connector 22 when the first and second electrical connectors 22 and 26 are mated, the second electrical connector 26 can be referred to as a plug or header connector. Alternatively, the second electrical connector 26 can be provided as a receptacle connector whereby the mating ends 65 are configured to receive plugs of a complementary electrical connector that is to be mated with the second electrical connector 26.

The first and second electrical connectors 22 and 26 may be shieldless high-speed electrical connectors, i.e., connectors that are devoid of metallic crosstalk plates between the electrical contacts 46 of the adjacent leadframe assemblies 56, and can transmit electrical signals across differential pairs at data transfer rates at or above four Gigabits/sec, and typically anywhere at or between 6.25 through 12.5 Gigabits/sec or more (about 70 through 35 picosecond rise times) with acceptable worst-case, multi-active crosstalk on a victim pair of no more than six percent. Worst case, multi-active crosstalk may be determined by the sum of the absolute values of six or eight aggressor differential signal pairs that are closest to the victim differential signal pair, as described in U.S. Pat. No. 7,497,736. Each differential signal pair may have a differential impedance of approximately 85 to 100 Ohms, plus or minus 10 percent. The differential impedance may be matched, for instance, to the respective substrates 24 and 28 to which the first and second electrical connectors 22 and 26 may be attached. The first and second electrical connectors 22 and 26 may have an insertion loss of approximately −1 dB or less up to about a five-Gigahertz operating frequency and of approximately −2 dB or less up to about a ten-Gigahertz operating frequency.

Referring now to FIGS. 2A-3, the first electrical connector 22 further includes at least one an electrically conductive member illustrated as an electrically conductive bar 60, that includes a first portion 62 that can be electrically conductive and a second portion 64 that can be electrically conductive and separate from the first portion 62 and configured to engage the first portion 62. For instance, the electrically conductive bar 60, and thus the first and second portions 62 and 64, can be made from a conductive material, including a metal and/or a non-metallic conductive absorbing material, such as an electrically conductive lossy material. Alternatively, the electrically conductive bar 60 may also be electrically non-conductive but still be frequency absorbing.

The first portion 62 is configured to be installed in a first select one of the leadframe assemblies 56 and supported by the respective leadframe housing 58, and a second portion 64 that is configured to be installed in a second select one of the leadframe assemblies 56 and supported by the respective leadframe housing 58. Thus, one of the leadframe assemblies 56 can include one of the first and second portions 62 and 64, and another one of the leadframe assemblies 56 can include the other of the first and second portions 62 and 64. The first select one of the leadframe assemblies 56 can be disposed adjacent to the second select one of the leadframe assemblies 56, such that no other leadframe assembly is disposed between the first and second select ones of the leadframe assemblies 56 along the row direction 39. The first and second portions 62 and 64 of the electrically conductive bar can engage such that each of the first and second portions 62 and 64 can bias the other of the first and second portions 62 and 64 apart along the row direction 39, for instance as indicated by Arrow 67 (FIG. 5C). Accordingly, each of the first and second portions 62 and 64 of the electrically conductive bar is biased toward the respective electrical contacts 46, and in particular toward the ground contacts G, of the respective leadframe assembly 56. The first and second select adjacent leadframe assemblies 56 can be provided as the first IMLA type 56a and the second IMLA type 56b. For instance, in accordance with one embodiment, the first select one of the leadframe assemblies 56 can be one of the first and second pluralities of the leadframe assemblies 56a-b, and the second select one of the leadframe assemblies 56 can be the other of the first and second pluralities of the leadframe assemblies 56a-b.

The leadframe housings 58 of the leadframe assemblies 56 each defines a respective pocket 66 at a location proximate to the mating end 48 of the electrical contacts 46, though it should be appreciated that the pocket 66 can be disposed anywhere along the leadframe assembly 56. The pocket 66 can have a length in the transverse direction T that extends across at least one ground contact G, such as a plurality, for instance all, of the ground contacts G of the respective leadframe assembly 56. In accordance with the illustrated embodiment, the pocket 66 spans across all electrical contacts 46 of the respective leadframe assembly 56. The pockets 66 are sized to receive one of the first and second portions 62 and 64 of the electrically conductive bar 60. The pockets 66 can include a first upper portion 66a and a second lower portion 66b that is offset with respect to the first upper portion 66a along the longitudinal direction L. For instance, the upper and lower portions 66a and 66b can extend parallel to each other, along the transverse direction T and thus substantially parallel to the column 53 in accordance with the illustrated embodiment, and the lower portion 66b can be disposed forward with respect to the upper portion 66a along the longitudinal direction L.

In accordance with the illustrated embodiment, the pocket 66 of the first select one of the leadframe assemblies 56 can extend laterally into the first outer surface 55 of the respective leadframe housing 58, and the pocket 66 of the second select one of the leadframe assemblies 56 that is disposed adjacent the first select one of the leadframe assemblies 56 can extend laterally into the second outer surface 57 of the respective leadframe housing 58 that faces the first outer surface of the leadframe housing 58 of the first select one of the leadframe assemblies 56.

As illustrated in FIG. 3, the first portion 62 and the second portion 64, and thus the bar 60, can be made from any suitable conductive material, such as a metal, conductive plastic, or any suitable alternative conductive material. Alternatively or additionally, the bar 60 can be made from a conductive or nonconductive electrical absorbing material, such as a lossy material. Each of the first and second portions 62 and 64 can define a first or inner surface 68 and an opposed second or outer surface 70 that is spaced from the inner surface along the lateral row direction 39. The inner surface 68 can face the electrical contacts 46 of the respective leadframe assembly 56, and the outer surface 70 of each of the first and second portions 62 and 64 of each bar 60 can face the outer surface 70 of the other of the first and second portions 62 and 64 of the bar 60, such that the first electrical connector 22 is devoid of electrical contacts between the first and second portions 62 and 64 that are installed in adjacent first and second leadframe assemblies 56a and 56b, and can be devoid of electrical contacts between the outer surfaces 70 of the first and second portions 62 and 64 that are installed in adjacent first and second leadframe assemblies 56a and 56b, for instance when at least one or both of the first and second portions 62 and 64 each comprise a lossy material. For instance, in accordance with one embodiment, a majority of the outer surfaces 70 of the first and second portions 62 and 64 that are installed in adjacent first and second leadframe assemblies 56a and 56b are separated by only air. Thus, the outer surfaces 70 of the first and second portions 62 and 64 that are installed in adjacent first and second leadframe assemblies 56a and 56b can touch each other, or can be spaced from each other along the row direction 39. It should be further appreciated that when the first and second portions 62 and 64 of the bar 60 comprise a lossy material, the bar 60 can be devoid of the bias assembly 78, and the first and second portions 62 and 64 can thus be devoid of the bias members 80 and 82. The first and second portions 62 and 64 can be mirror images of each other, such that the upper and lower portions 72 and 74 of the first portion 62 is aligned with the upper and lower portions 72 and 74 of the second portion 64 when the respective outer surfaces 70 face each other. At least one or both of the inner and outer surfaces 68 and 70 can be substantially planar, or contoured as desired such that regions on the first and second portions 62 and 64 are closer to the ground contacts G than the signal contacts S of the respective leadframe assembly 56.

Each portion 62 and 64 defines an upper end 72 and a lower end 74 that is offset with respect to the upper end 72 along the longitudinal direction L so as to correspond to the shape of the pockets 66. For instance, the upper and lower ends 72 and 74 can extend parallel to each other, along the transverse direction T and substantially parallel to the column 53 in accordance with the illustrated embodiment, such that the lower end 74 is forwardly spaced from the upper end 72 along the longitudinal direction L. The first and second portions 62 and 64 can be retained in the respective pockets in any manner as desired. In accordance with the illustrated embodiment, the leadframe assemblies 56 can each include at least one retention member such as a first protrusion 81 that extends longitudinally out from the upper portion 72 and at least one second protrusion 83 that extends longitudinally out from the lower portion 74. For instance, each of the first and second portions 62 and 64 can include a pair of first protrusions 81 that extend forward and rearward, respectively, from the upper portion 72 along the longitudinal direction L, and are configured to be press-fit in the respective pocket 66 such as at the upper portion 66a.

The first protrusions 81 can define a pair of first protrusions 81 that can be aligned with each other as illustrated, or offset with each other along the transverse direction T as desired. Furthermore, each of the first and second portions 62 and 64 can include a pair of second protrusions 83 that extend forward from the lower portion 74 along the longitudinal direction L. One of the pair of second protrusions 83 can extend through a gap 85 of the respective leadframe housing 58 that is open to the pocket 66, while the other of the second protrusions 83 can be sized so as to be press-fit in the pocket 66 such as at the lower portion 66b. Alternatively or additionally, the portions 62 and 64 can staked, latched, glued, or otherwise fixed to the respective leadframe housings 58 in the pockets 66. Alternatively, the portions 62 and 64 can be trapped between the leadframe assemblies 56 once the leadframe assemblies 56 are secured to the connector housing 30 without first fixing the portions 62 and 64 to the leadframe housings 58. When the first and second portions 62 and 64 are fully inserted into the respective pockets 66, the outer surfaces 70 can be recessed from, flush with, or extend out from the leadframe housing 58.

In accordance with one embodiment, the portions 62 and 64 can be fully inserted in the respective pockets 66 to a depth at a location closely spaced to the ground contacts G. For instance, when the portions 62 and 64 are fully seated in the pockets 66, a desired non-zero lateral gap extends along the lateral direction L between the inner surfaces 68 of the first and second portions 62 and 64 and the respective electrical contacts 46 (e.g., ground contacts G). In accordance with one embodiment, the gap can be between 0.001 inch and 0.005 inch, for instance approximately 0.002 inch. Thus, the portions 62 and 64 are not placed in contact with the electrical contacts 46, but are placed in close proximity to the electrical contacts 46, and in particular the ground contacts G of the respective leadframe assembly 56. Accordingly, the first and second portions 62 and 64 do not touch the ground contacts G when the first and second portions 62 and 64 are fully seated in the respective pockets 66.

In accordance with one embodiment, each pocket 66 can define a depth that extends laterally into the respective leadframe housing 58 from the respective first and second outer surfaces 55 and 57 that is less than the distance between the respective first and second outer surface 55 and 57 and the respective electrical contacts 46. As a result, when the electrically conductive bars 60 are fully seated in the respective pockets 66, the bars 60 do not contact the electrical contacts 46 and are spaced from the electrical contacts 46 by the lateral gap. Alternatively or additionally, at least one or more up to all of the projections 81 and 83 can also extend laterally out from the upper and lower ends 72 and 74 as desired. The projections 81 and 83 can be an electrically nonconductive dielectric material, and for instance can be overmolded onto the first and second portions 62 and 64, and can have a lateral thickness substantially equal to the lateral gap. In this regard, it should be appreciated that the projections 81 and 83 can define dielectric spacer members 87 that space the first and second portions 62 and 64 from the respective electrical contacts 46, including at least one up to all of the ground contacts G. Alternatively or additionally, the spacer members 87 can be defined by the leadframe housing 58 that separates the electrical contacts 46 from the first and second portions 62 and 64. It should be further appreciated that the first and second portions 62 and 64 could be configured to contact the respective ground contacts G (e.g., such that the lateral gap is zero), thereby establishing a continuous ground path across the ground contacts G, for instance once the first and second portions 62 and 64 are fully seated in the respective pockets 66.

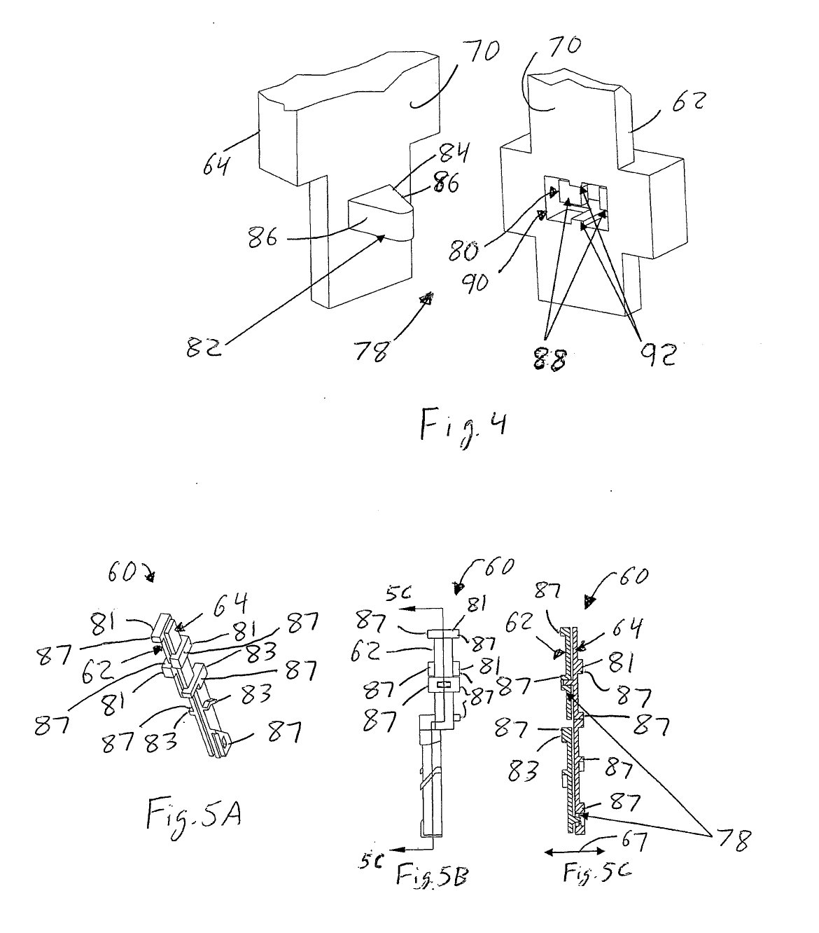

Referring now to FIGS. 3-5C, the conductive bar 60 includes a bias assembly 78 that is configured to bias the portions 62 and 64 laterally toward the electrical contacts 46 of the respective leadframe assemblies 56 and away from each other. In particular, the bias assembly 78 includes at least one pair of first and second complementary bias members 80 and 82. As illustrated, one of the first and second portions 62 and 64 can carry the first bias member 80, and the other of the first and second portions 62 and 64 can carry the second bias member 82. The first and second bias members 80 and 82 are configured to engage each other so as to bias the first and second portions 62 and 64 laterally away from each other and toward the electrical contacts 46 of the respective leadframe assembly 56.

The first and second bias members 80 and 82 can be constructed in any manner desired so as to apply a biasing force of against the first and second portions 62 and 64, respectively. In accordance with the illustrated embodiment, one of the first and second portions 62 and 64, for instance the outer surface 70 of one of the first and second portions 62 and 64, can carry one or both of the first and second bias members 80 and 82, while the other of the first and second portions 62 and 64, for instance the outer surface 70 of the other of the first and second portions 62 and 64, can carry the other or both of the first and second bias members 80 and 82. The first bias member 80 is illustrated as at least one bias tab 88, such as a pair of bias tabs 88 that are longitudinally spaced and disposed in a recess 90 that extends into the outer surface 70. The second bias member 82, which can be in the form of a projection 84 that extends from the outer surface 70 and defines opposed sloped outer cam surfaces 86 that are tapered toward each other toward as they extend toward the other of the first and second portions 62 and 64. The projection 84 can be sized to be received between the bias tabs 88 which can be deflectable away from each other, and are spaced so as to deflect away from each other as the tapered cam surface 86 is inserted between the bias tabs 88.

In accordance with the illustrated embodiment, the first portion 62 carries the first bias member 80, and the second portion 64 carries the second bias member 82, though it should be appreciated that the first portion 62 can carry the second bias member 82, and the second portion 64 carries the first bias member 80. As the bias tabs 88 deflect, they impart a spring force onto the cam surfaces 86. Because the cam surfaces 86 are sloped with respect to the lateral direction A, the longitudinal force imparted onto the cam surfaces 86 by the bias tabs 88 biases the projection 84 away from the bias tabs 88, and thus biases the corresponding second portion 64 laterally toward the respective electrical contacts 46. A substantially equal and opposite lateral force is imparted from the projection 84 onto the bias tabs 88, which biases the corresponding first portion 62 in a direction toward the respective electrical contacts 46. Accordingly, the bias assembly 78 biases the first and second portions 62 and 64 toward the respective electrical contacts 46 to a fully seated position inside the respective pockets 66, such that the spacer members 87 define the desired lateral gap between the respective first and second portions 62 and 64 and the respective electrical contacts 46.

At least one of the first and second portions 62 and 64, for instance the first portion 62 as illustrated, can further include at least one alignment rib 92 such as a pair of opposed upper and lower alignment ribs 92 that are aligned with the upper and lower surfaces of the bias tabs 88. Accordingly, the alignment ribs 92 provide a guide that maintains the projection 84 in alignment with the bias tabs 88 when the portions 62 and 64 are engaged. It should thus be appreciated that the bias assembly 78 is configured to align the first and second portions 62 and 64 of the conductive member 60 in the lateral, longitudinal, and transverse directions. Furthermore, the pockets 66 and the bias assembly 78 can cooperate to ensure that the first and second portions 62 and 64 of the conductive members 60 are not inadvertently displaced along the longitudinal L or transverse T directions during operation.

During operation, the first and second portions 62 and 64 are inserted into the pockets 66 of the respective leadframe assemblies 56 such that the respective first and second bias members 80 and 82 face each other and are aligned with each other. Next, the leadframe assemblies 56 are mounted to the connector housing 30 such that the bias members 80 and 82 of the portions 62 and 64 engage, which produces a force against both portions 62 and 64 that biases the portions 62 and 64 toward the respective electrical contacts 46, which causes the portions 62 and 64 to remain fully seated in their respective pockets 66 such that the respective inner surfaces 68 are maintained in a position spaced from the electrical contacts 46 by the desired gap. The portions 62 and 64 can alternatively be mechanically fastened to the leadframe housing 58 at a desired depth prior to installing the leadframe assemblies 56 in the connector housing 30, such that inner surfaces 68 are spaced from the electrical contacts 46 by the desired gap even though the first electrical connector 22 can be devoid of the bias assembly 78. It is believed that the conductive bar 60 increases signal integrity of the first electrical connector by providing resonance dampening, which reduces cross talk produced during operation of the electrical connector system 20.

Thus, in accordance with one embodiment, a method can be provided for reducing cross-talk of an electrical connector. The method can include the step of providing or teaching the use of an electrical connector, such as the first electrical connector 22 having the connector housing 30 and a plurality of leadframe assemblies 56 supported by the connector housing 30. The method can further include the step of identifying first and second adjacent leadframe assemblies 56 of the electrical connector, and teaching the step of creating a pocket, such as the pocket 66, in opposed first and second outer surfaces 55 and 57 of first and second leadframe housings of the first and second leadframe assemblies 56, respectively, such that the opposed first and second outer surfaces 55 and 57 face each other when the first and second leadframe assemblies 56 are supported by the connector housing 30. The method can further include teaching the step of disposing, for instance inserting, first and second electrically conductive portions, such as the first and second portions 62 and 64, of a conductive bar, such as the bar 60, in the pockets of the first and second leadframe assemblies 56, respectively. The first and second portions 62 and 64 are separated from the electrical contacts 46 of each of the leadframe assemblies 56 by a non-zero gap that can be sized as desired, for instance between 0.001 inches and 0.005 inches, such as 0.002 inches.

The embodiments described in connection with the illustrated embodiments have been presented by way of illustration, and the present invention is therefore not intended to be limited to the disclosed embodiments. Furthermore, the structure and features of each the embodiments described above can be applied to the other embodiments described herein, unless otherwise indicated. For instance, it should be appreciated that the first and second portions 62 and 64 can alternatively be integrally connected or discretely connected such that the bar is unitary prior to insertion into the pockets 66. Alternatively or additionally, it should be appreciated that while the first and second select leadframe assemblies 56 define pockets 66 in the opposed first and second outer surfaces 55 and 57 that face each other, the first and second select leadframe assemblies 56 can define pockets 66 on the same side of the leadframe housing 58 along the connector 22, such adjacent that the pockets 66 of the adjacent leadframe assemblies 56 do not face each other. Rather, the first and second portions 62 and/or 64 can be inserted into the respective pocket 66 so as to be disposed adjacent a surface 55 or 57 of the adjacent leadframe assembly 56 that does not include a pocket 66. Accordingly, those skilled in the art will realize that the invention is intended to encompass all modifications and alternative arrangements included within the spirit and scope of the invention, for instance as set forth by the appended claims.

What is claimed:

1. An electrical connector comprising:
a connector housing;
a first leadframe assembly supported by the connector housing, the first leadframe assembly including a first leadframe housing and a corresponding plurality of electrical contacts carried by the first leadframe housing that are configured to transmit data signals;
a second leadframe assembly that is adjacent to the first leadframe assembly, the second leadframe assembly including a second leadframe housing and a corresponding plurality of electrical contacts carried by the second leadframe housing that are configured to transmit data signals;
an electrically conductive member including a first portion and a second portion, the first portion supported by the first leadframe housing so as to define a gap with respect to the plurality of electrical contacts corresponding to the first leadframe assembly, and the second portion carried by the second leadframe housing so as to define a gap with respect to the plurality of electrical contacts corresponding to the second leadframe assembly,
wherein the first and second portions face each other when the first and second leadframe assemblies are supported by the connector housing, such that the electrical connector is devoid of electrical contacts between the first and second portions.

2. The electrical connector as recited in claim 1, wherein the gap is non-zero.

3. The electrical connector as recited in claim 1, further comprising a dielectric spacer member that maintains each of the first and second portions at a location spaced from the respective electrical contacts by the respective gap.

4. The electrical connector as recited in claim 3, wherein the dielectric spacer member comprises a dielectric material that extends out from each of the first and second portions.

5. The electrical connector as recited in claim 1, wherein the first and second leadframe assemblies are spaced along a row direction, and the electrical contacts of each of the first and second leadframe assemblies are spaced along a column direction that is substantially perpendicular to the row direction.

6. The electrical connector as recited in claim 5, wherein each of the first and second portions includes a first end and a second end that extend substantially parallel to the column of the respective leadframe assembly.

7. The electrical connector as recited in claim 6, wherein one of the first and second ends is offset with respect to the other of the first and second ends along a direction that is substantially perpendicular to both the row and column directions.

8. The electrical connector as recited in claim 1, wherein the electrical contacts of each of the first and second leadframe assemblies each define a mounting end configured to electrically connect to a complementary electrical component and a mating end configured to mate with a complementary electrical connector, and the first and second members are disposed proximate to the mating ends of the electrical contacts of the respective leadframe assembly.

9. The electrical connector as recited in claim 9, wherein each leadframe housing of the first and second leadframe assemblies define respective pockets that receive the first and second portions, respectively.

10. The electrical connector as recited in claim 1, wherein the conductive member further comprises a bias assembly that biases the first and second portions of the conductive member away from each other and toward the electrical contacts of the respective leadframe assembly.

11. The electrical connector as recited in claim 1, wherein the bias assembly comprises a projection that extends out from one of the first and second portion, and a pair of bias tabs carried by the other of the first and second portions, the bias tabs configured to receive the projection and apply a force to the projection that biases the projection away from the bias tabs.

12. The electrical connector as recited in claim 11, wherein bias tabs are deflectable away from each other when the projection is received between the bias tabs.

13. The electrical connector as recited in claim 1, wherein the electrical connector is devoid of a metallic crosstalk plate between the electrical contacts of the first and second leadframe assemblies.

14. The electrical connector as recited in claim 1, wherein the electrical contacts of each of the first and second leadframe assemblies include at least one differential signal pair and at least one ground contact disposed adjacent the differential signal pair.

15. The electrical connector as recited in claim 1, wherein each of the first and second portions comprises a lossy material.

16. A method of reducing cross-talk of an electrical connector, the method comprising the steps of:
providing or teaching the use of an electrical connector, such as the first electrical connector having the connector housing and a plurality of leadframe assemblies supported by the connector housing;
identifying first and second adjacent leadframe assemblies;
teaching the step of creating a pocket in opposed first and second outer surfaces of first and second leadframe housings of the first and second leadframe assemblies, respectively, such that the opposed first and second outer surfaces face each other when the first and second leadframe assemblies are supported by the connector housing; and
teaching the step of disposing first and second electrically conductive portions of a conductive bar in the pockets of the first and second leadframe assemblies, such that the first and second portions are separated from electrical contacts of the respective first and second leadframe assemblies by a non-zero gap.
